(19) United States
(12) Patent Application Publication
(10) Pub. No.: US 2004/0052446 A1
(43) Pub. Date: Mar. 18, 2004

(54) Optical data interface for communication devices

(76) Inventors: Livne Gan, Omer (IL); Ron Gutterman, Ganey Tikva (IL)

Correspondence Address: BROWDY AND NEIMARK, P.L.L.C., 624 NINTH STREET, NW, SUITE 300, WASHINGTON, DC, 20001-5303, US

(21) Appl. No.: 10/241,757

(22) Filed: Sep. 12, 2002

(51) Int. Cl. G02B 6/42

(52) U.S. Cl. 385/15; 385/88

(57) ABSTRACT

A method and system for communicating a signal between a communication device and an external circuit, includes a signal conversion unit connected to the communication device responsive to a received electromagnetic signal for producing a corresponding optical signal component, and an optical fiber cable coupling the signal conversion unit to the external circuit for propagating the optical signal component to the external circuit. A signal filtering processor is coupled between the communication device and the signal conversion unit for processing the electromagnetic signal prior to converting to the optical signal component.

### FIELD OF THE INVENTION

This invention relates to communication systems. In particular, the present invention relates to a system and method for transferring data between communication devices and other electronic devices.

### BACKGROUND OF THE INVENTION

Data transmitted by communication systems can represent many different types of information, including, for example, voice channels, full motion video, and computer data. Parallel to the developments in the communication technologies, the increase in computing power and high-speed data processing has spurred the need to share information among computers. Computer users constantly need to share information and services while allowing full mobility.

Many different communication technologies support different services to their users, using a wide range of protocols and transport options. Cellular and cordless phones, pagers and mobile radio units, among the rest use radio frequencies for transport. Infrared, ultrasonic communication and other technologies also play a role as transport methods.

The use of communication devices for audio and video data streaming, Internet communications transmission and other media types requires high bandwidth, to support fast and reliable data transmission. However, wide bandwidth wireless communication devices are usually characterized by the emission of electromagnetic radiation; the wider the bandwidth, the higher the frequency, and the higher the amplitude, the greater is the damage caused by the electromagnetic radiation emitted from the device. There is increasing evidence that this electromagnetic radiation affects and damages biological tissue. This radiation also creates electromagnetic interference, disturbing other electronic devices adjacent to the wireless device.

Furthermore, by increasing the amplitude, it is possible to achieve a clearer signal, thereby achieving better processing. However, as before, the higher the amplitude, the greater is the damage caused by the electromagnetic radiation.

Therefore it is often considered preferable to keep wireless devices as distant as possible from the human body during communication. Also it is considered preferable to keep wireless communication devices as distant as possible from other electronic devices.

Communication devices can be coupled to various end units, such as computers, video monitors, audio devices (e.g. earpieces and/or microphones) etc. However, embedding the communication device in the end units results in the above limitations of electromagnetic radiation and interference, thus impacting on the performance and/or safety of the end units. In order to overcome the above limitation and avoid the need to embed the communication devices within the end units, they can be coupled to the end units, most commonly, through metallic conductors. However, such cables do not solve the radiation problem: to the contrary, the metallic conductor actually becomes an antenna, conducting, and probably also amplifying the emitted radiation.

WO 01/13661 (Qualcomm Incorporated) describes a system for connecting a wireless phone to an external circuit. The system includes a first optical data interface adapter connected to the wireless phone and a second optical data interface adapter, connected to the external circuit. A fiber optic cable connects the first optical data interface adapter to the second optical data interface adapter.

Such a system transmits the data received by the wireless telephone to the external circuit “as is”, without modification. Therefore, if such a system is used with a high bandwidth telephone transmitting a large amount of data, the system requires the use of a high diameter optical fiber cable, supporting a wide enough bandwidth, or it will suffer from delays and loss of data. Optical fiber cables are expensive resources, and their cost increases as their diameter increases. Therefore, from purely cost considerations it is preferable to use as low diameter fibers as possible. Moreover, low diameter fibers are suitable for some applications, such as optical microphones (Phone-or's LiteMic is an example for a commercially available optical microphone model), which would be impractical to implement using high gauge cables. However, the use of low diameter optical fiber cables militates against their use for high bandwidth data transmission, which is becoming increasingly required. It would clearly be desirable to modify the system described in WO 01/13661 so as to allow high bandwidth communication albeit using low diameter optical fiber cables.

Signal conversion units are now on the market that directly convert an optical signal to a desired output, or vice versa, i.e. convert any kind of input, such as electromagnetic signals to optical signals. For example, optical CD players and recorders (an example of a commercially available optical CD player and recorder is model DN-C550R manufactured by Demon) convert an optical signal directly to audio data and vice versa without any need to convert first to a corresponding electrical signal. However, if such signal conversion units are used in the system described in WO 01/13661, the optical signal propagated through the optical fiber cable is converted to an electrical signal that is fed to a computer. It would therefore be necessary to couple a third signal conversion unit to the computer for reconverting the signal back to an optical signal. The computer, as well as the third signal conversion unit, both introduce delays as well as introducing components that are redundant and increase the cost of the system with no benefit.

It is further necessary to understand that during propagation of a signal along an optical fiber cable, a carrier light wave is propagated along the optical fiber, which carries a data component. The carrier is characterized by a deflection angle, characterizing its deflection when impinging on to the optical fiber's wall. The carrier is used to carry modulated optical data components.

### SUMMARY OF THE INVENTION

In order to address the above-mentioned drawbacks, there is provided in accordance with a first aspect of the invention a system for communicating a signal between a communication device and an external circuit, the system comprising:

a signal conversion unit connected to said communication device responsive to a received electromagnetic signal for producing a corresponding optical signal component, and

an optical fiber cable coupling said signal conversion unit to the external circuit for propagating said optical signal component to the external circuit;

characterized in that:

a signal filtering processor is coupled between said communication device and said signal conversion unit for processing the electromagnetic signal prior to converting to the optical signal component.

The invention further provides for a system for communicating a signal between a communication device and an external circuit, the system comprising:

a signal conversion unit connected to said communication device responsive to a received electromagnetic signal for producing a corresponding optical signal, and

an optical fiber cable coupling said signal conversion unit to the external circuit for propagating said optical signal to the external circuit;

characterized in that:

a signal filtering processor is coupled between at least one said communication device and said signal conversion unit for identifying and processing the electromagnetic signal prior to converting to the optical signal, and

an optical filter is coupled between the signal conversion unit and the optical fiber for receiving the optical signal and producing at least one corresponding filtered optical signal component.

Still further, the invention provides for a method for communicating a signal between a communication device and an external circuit, the method comprising:

One) processing an electromagnetic signal output by the communication device for automatically identifying a respective communication protocol thereof,

Two) filtering the electromagnetic signal prior to converting to an optical signal component,

Three) converting the electromagnetic signal to the optical signal component, and

One) conveying the optical signal component via an optical fiber cable to the external circuit.

The invention supports the use of low diameter optical fiber cables by processing the data received at the communication device, before converting the electromagnetic signal to optical signals, and performing signal filtering on the received signal. The signal filtering is performed by a signal filtering processor coupled between the communication device and a signal conversion unit. The signal conversion unit may include photodetectors and transmitters as is known in the art and converts the filtered signals into optical signals, and possibly propagates more than one optical signal along the optical fiber, such that each optical signal is characterized by a unique deflection angle. To this end, the filtered signals can be suitable for specific end-units such as CD players in the case of audio data. Therefore, in the event that the end-units are optical (e.g. optical CD players) they may be coupled directly to the optical fiber without requiring intermediate conversion to and from an electrical signal. This provides a mechanism that prevents the delay characteristic of the system described in WO 01/13661.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic representation of one proposed embodiment of the invention.

FIG. 2 is a schematic representation of another proposed embodiment of the invention, supporting many different communication devices.

FIG. 3 schematically illustrates time slot division.

FIG. 4 is a schematic representation of yet another proposed embodiment of the invention, including an optical filter.

FIG. 5 is a flow chart illustrating the functionality of the signal filtering processor.

FIG. 6 illustrates filtering an optical signal component characterized by a certain wavelength out of an optical fiber.

FIG. 7 illustrates combining two different optical signal components to activate a single external circuit.

### DETAILED DESCRIPTION OF SPECIFIC EMBODIMENTS

In the following description, components that are common to different embodiments are referenced by identical reference numerals.

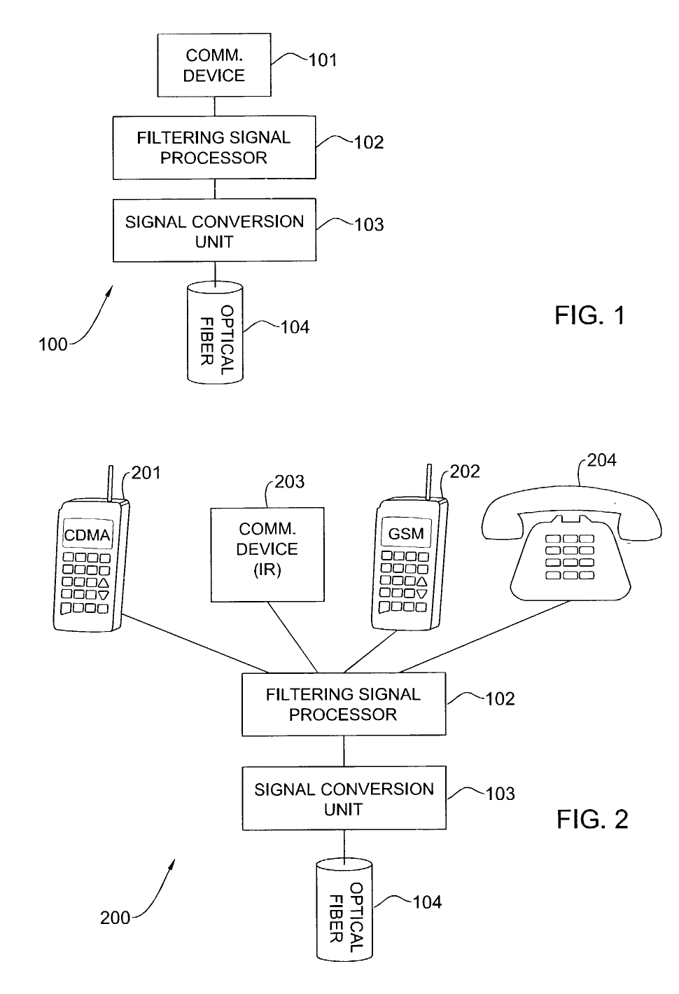

FIG. 1 shows a schematic representation of a system 100 according to a first embodiment of the invention. A communication device 101 is connected to a signal flittering processor 102. Downstream a signal conversion unit 103 translates the electromagnetic signal received from the communication device and the signal flittering processor to an optical signal, which further propagates along the optical fiber cable 104, and vice versa, the system being bi-directional. Optical signals propagate along the optical fiber cable 104, and impinge on the signal conversion unit 103, where they are converted to electromagnetic signals. The electromagnetic signals propagate towards the signal filtering processor 102 and the communication device 101, which further transmits them according to the communication protocol in use.

Any type of communication device can be connected to the system 100 in accordance with the invention. Many communication devices characterized by different communication protocols and transports for wireless and wired data transmission exist in the market. For example, regular telephones, cellular TDMA, cellular CDMA, satellite and infrared communication, Bluetooth devices etc are know. Each of these communication devices uses different communication channels or protocols to transmit data. To avoid the need to manufacture different signal filtering processors for different communication devices, the signal filtering processor described by the invention provides the ability to identify the transmission method, therefore allowing the use of a single signal filtering processor for any communication device.

Furthermore, the system 100 enables using a single processor for receiving data from more than one device at the same time, as shown in FIG. 2, showing schematically a system 200 according to a second embodiment of the invention, supporting many different communication devices. This embodiment utilizes the optical fiber cable's ability to conduct higher capacities of data, compared to a metal conductor.

Thus, as shown in FIG. 2, the single signal filtering processor 102 connects to four different communication devices: a cellular CDMA telephone 201, a cellular GSM telephone 202, a wireless infrared (IR) communication device 203 and a regular telephone 204. The filtered electromagnetic signals propagate to the signal conversion unit 103, where they are converted to optical signals, which propagate through the optical fiber cable 104. By such means, the optical fiber cable 104 can conduct data received by more than one communication device according, to its higher conductance capacity.

As in the system 100 shown in FIG. 1, also in the system 200 illustrated in FIG. 2, the signals can propagate in the opposite direction, upon being transmitted by the appropriate communication device according to criteria stored in the signal filtering processor.

Use of the system 200 will now be described by way of example. A doctor is carrying a laptop computer for typing his conclusions (textual data). The doctor uses an EKG monitor to perform EKG tests on his patients. In urgent cases he transmits the EKG results (the EKG graphs' data) to a remote medical center, while at the same time also speaking with personnel situated at the medical center (audio data) via an optical microphone, to give his indications orally. The laptop, the EKG monitor and the optical microphone all have optical interfaces and are connected to the optical fiber cable. The doctor can configure the signal filtering processor to transmit the EKG graphs' data through the cellular GSM mobile telephone 202, the textual data through the IR communication device 203, and the audio data through the regular telephone 204.

While transmitting data through a communication channel, the data occupies a certain fraction (or the whole) of the available bandwidth. Many sources of data, e.g. a full motion video, require a higher bandwidth than the available capacity, which in turn requires a wider range of frequencies dedicated for the transmission for increasing the bandwidth. The increased range of frequencies involves higher radiation emitted from the wireless communication devices. To avoid this limitation, or to improve the performance, it is possible to use digital compression. However, simple digital compression may still result in data requiring a high bandwidth channel for propagation and therefore more advanced compressions are preferred.

On the other hand, some data do not utilize all the available bandwidth of a communication channel. In such case, while transmitting data through a communication channel, it is also possible to transmit from numerous sources in parallel (the signal from each source constituting a signal component), coding their data altogether to generate a composite signal. For example, medical data such as the representation of EKG graphs can be transmitted together with audio signals and textual data. The composite signal is characterized by a better utilization of the available bandwidth, as opposed to the regular, single signal transmission.

The composite signal may be produced in three ways. According to a first approach, a fraction of the available bandwidth is utilized for transmitting a first analog signal, while adding a second analog signal to the unutilized bandwidth. The first analog signal is referred to as the first analog component of the composite signal, while the second signal is referred to as the second analog component of the composite signal. In this case a conventional receiver can always receive all the analog components of the signal. According to a second approach, the second signal is a digitally compressed signal, referred to as the second digital component of the composite signal, which is added to the first analog component. In this case, a conventional receiver can always receive the first analog component of the signal, but to receive the second digital component, the receiver must have a suitable decoder, able to decode digital data. According to a third approach, both signals are compressed digitally requiring the receiver to have a suitable decoder in order to receive and decode any one of the received components.

To receive and decode the digital components of the signal, both the transmitter and the receiver must be equipped with a respective encoder/decoder using an identical communication protocol.

According to the invention, the signal filtering processor detects an incoming signal and identifies whether the signal is a composite electromagnetic signal or a simple one. When the incoming signal is found to be a composite signal, the signal filtering processor detects and decodes the constituent signals of the transmitted composite signal, splitting it into electromagnetic signal components. In the case of a composite incoming signal, the total bandwidth occupied together by all the split signal components is higher than the bandwidth occupied by the composite signal. The signal filtering processor recognizes and identifies different signals using known headers characteristic of each, as known to those versed in the art.

The connection between the signal filtering processor and the signal conversion unit has a limited bandwidth, i.e. a limited data capacity. Moreover, the same limitation exists for the optical fiber cable, which must be kept as narrow as possible. To further convey the composite signal's optical components (or the simple signal, in the case that the received signal was detected as such) over as narrow a bandwidth channel as possible, the signal filtering processor may perform time slot division multiplexing. In time slot division multiplexing, each of the signal's electromagnetic components may be conveyed by the signal filtering processor during a respective time slot. Downstream, the signal conversion unit converts each electromagnetic component, carried by a dedicated time slot, to the equivalent optical signal component prior to being transmitted over the optical fiber cable. To enable real time transmission, the time slots must altogether occupy no more than a predetermined time period (for example 125 microseconds in TDMA).

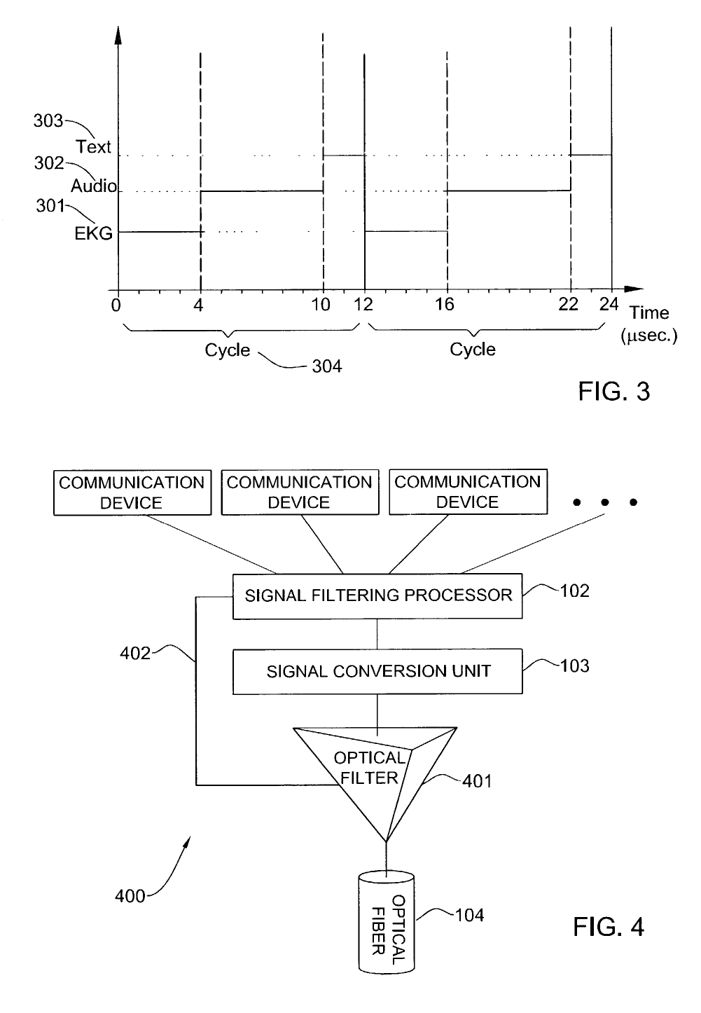

FIG. 3 schematically illustrates time slot division, splitting a composite electromagnetic or optical signal, composed of EKG graphs' data component 301, audio data component 302 and textual data component 303 into three time slots occupying altogether a 12 microsecond cycle 304. The cycles' composition repeats itself as long as the three components coexist and compose together the composite signal. Moreover, the different components may occupy time slots characterized by a different duration. In the example illustrated in FIG. 3, the EKG component 301 occupies time slots of four microseconds, the audio data component 302 occupies time slots of six microseconds and the textual data component occupies time slots 303 of two microseconds.

A total duration of the time slots longer than the predetermined time period (12 microseconds in the example illustrated by FIG. 3) results in a delayed transmission, and probably also in data loss. However, it may happen that the nature of the received signals requires more than the predetermined time period altogether. For example, in the case of a predetermined time period of 12 microseconds, if the received composite transmission contains two video signal components, splitting them into two time slots of 6 microseconds each will not suffice for a quality video transmission. Therefore, the signal filtering processor must determine which of the two is more important and transmit it first, dedicating enough bandwidth for it. Identification and priority determination in this case can be based on the transmission's source. In the above example of a doctor communicating with a remote medical center or hospital, a video transmitted by the hospital's information departments is more important than a video transmitted to him by any other source. The less important signal component, in this example, can be processed in different ways. For example, the signal filtering processor can record the signal component for a later playback, or ignore it and discard the data. A different approach may be to transmit both signal components while reducing the respective qualities of both. In the above example, 6 microseconds will be dedicated for each signal component, whereby both video signals will reach their destination, albeit with reduced quality.

According to the invention, it is possible to configure the signal filtering processor, in a way that grades, or prioritizes the signals according to their types and according to their relative importance. For example, EKG graphs may be more important than audio data, which in turn may be more important than video signals and so on. The signal filtering processor may be responsive to the grading, thus applied so as to allocate component signals within the time slots according to their relative importance so that a signal component of high importance is given preference to one of lesser importance. The signal filtering processor's configuration also allows a received signal having an unrecognized or unwanted signal type to be automatically discarded. Upon receipt of an unrecognized signal type, the processor can transmit it “as is” or ignore it. While transmitting this signal, as the signal filtering processor does not know what is the minimal required time slot, it can delay the signal, and dedicate all the predetermined time period (in the above example 12 microseconds) to it, when it is available. According to the invention, it is possible to define the signal types known by the signal filtering processor, and introduce new signal types when needed.

It should be noted that the terms “signal component”, “component signal” and “data component” are used interchangeably, and they all mean the same.

Another embodiment of the invention relates to a signal filtering processor that performs frequency and phase division multiplexing on the composite signal, instead of time slot division. The components of the electromagnetic composite signal are split, and converted by the signal conversion unit to predetermined frequencies and phases characterizing the corresponding optical signal components. The carrier can then carry multiple optical data components, either having a different wavelength, and/or having the same wavelength, but being mutually orthogonal. It is also possible to have multiple carriers propagating along the optical fiber, each carrying single or multiple optical data components. A different embodiment relates to the usage of a bundle of optical fibers, forming together an optical fiber cable, on each fiber of which a carrier is forwarded. A combination of the described embodiments is also possible. It will be understood that the above embodiments of frequency and phase division are merely representative, non-limiting examples.

The signal filtering processor can command the signal conversion unit to propagate several optical signal components at the same time along the optical fiber cable, thus distinguishing the current invention over the invention described in WO 01/13661. According to one embodiment, the signal conversion unit may contain a prism, such as a pentaprism (a commercially available example being that manufactured by Oriel under catalog number 46200), propagating different optical signal components with different deflection angles. Other embodiments may use other optical means such as mirrors, filters or combinations thereof Controlling the signal conversion unit by the optical filtering processor is known to those versed in the art.

Note also that time slot division, frequency and phase division or a combination of both can be performed for multiplexing several components of a composite electromagnetic signal received from a single communication device, or for multiplexing several simple electromagnetic signals received from multiple communication devices, or for a combination of both.

In all the previously described embodiments, the signal filtering processor performs signal manipulations (such as time slot division or frequency and phase division) on the received electromagnetic signals, which are then converted to optical signals by the signal conversion unit. According to the invention, it is possible to obtain further improvement by means of a system 400 according to another embodiment of the invention illustrated in FIG. 4. The system 400 includes an optical filter 401 coupled between the signal conversion unit 103 and the optical fiber cable 104. The signal filtering processor 102 controls the optical filter 401 by an appropriate control signal 402, allowing it to perform optical manipulations (such as time slot division or frequency and phase division) to produce filtered optical signal components. It is possible to achieve an optical filter 401 for example by using a micro video imaging leans, and by controlling the lens's angle relative to the signal conversion unit 103 and to the optical fiber cable 104. An example of a commercially available lens can be found in Edmund Industrial Optics, catalog number N001B.

Note that the filtered optical signal components are equivalent to the previously described optical signal components.

Filtering by optical means is more efficient than performing filtration of the electromagnetic waves by the signal filtering processor. The signal filtering processor directs the optical filter to perform time slot division and/or frequency and phase division in order to multiplex several components of a composite signal, in order to multiplex several simple signals received from multiple communication devices, or in order to multiplex a combination of both.

It should be noted that whereas the embodiments described so far relate to systems having only one signal conversion unit, one optical filter and one optical fiber cable, if desired, multiple signal conversion units and/or multiple optical filters and/or multiple optical fiber cables may also be used.

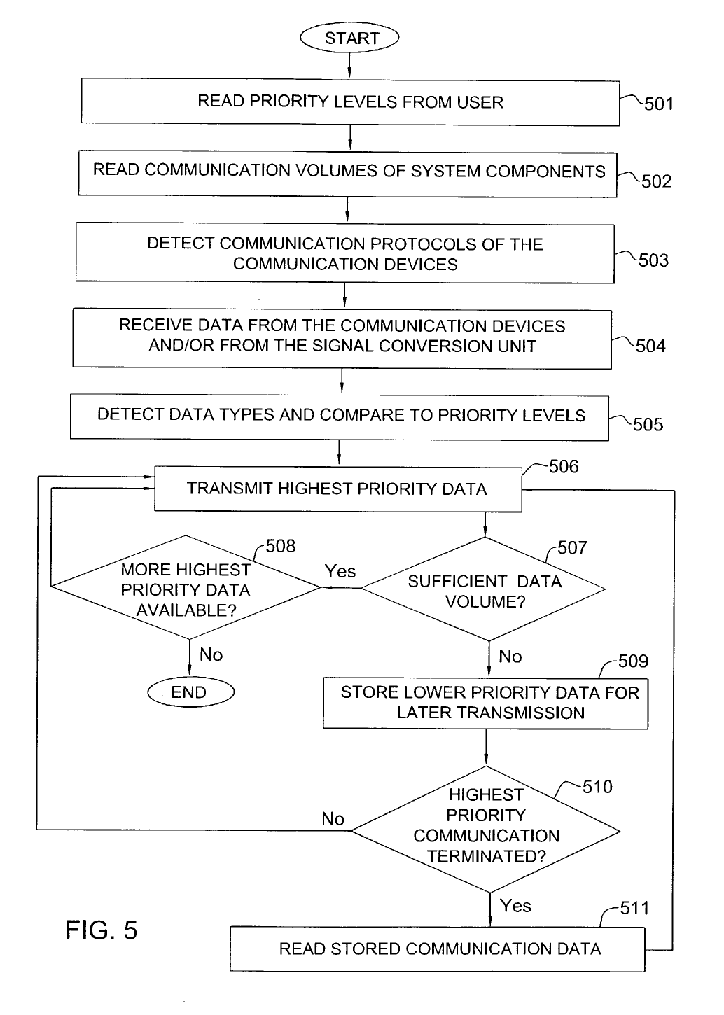

FIG. 5 is a flow chart illustrating the operation of the signal filtering processor. On startup denoted by step 501, the processor reads the priority levels set by the user, according to which a received signal will later be graded. Priority can be inserted by the user on the fly, or it may be read from memory, such as non-volatile memory. At step 502, the signal filtering processor then reads the communication volumes supported by the different components of the system, such as communication devices and optical fiber cable, in order to later be able to filter and route communicated data. Finally at step 503, the signal filtering processor detects the communication protocol of the connected communication devices. Now the signal filtering processor is ready to start receiving and/or transmitting data as designated by step 504, i.e. the signal filtering processor is ready to start receiving data from the communication devices or from the signal conversion unit. At step 505, the processor detects the data type and compares it to the priority levels read at step 501, and, at step 506, transmits (to the signal conversion unit or to the communication devices) the highest priority data according to the available communication volume and priority levels. If at step 507 the supported data volumes suffice and as long as step 508 determines that there is more communication data to transmit, the signal filtering processor continues to transmit the highest priority data which is currently all the data it has to transmit. However, if step 507 determines that there is insufficient data volume supported by the communication devices to transmit all the received data, then at step 509, the signal filtering processor stores lower priority data for later transmission. In the case where the signal filtering processor is embedded in a portable computer, lower priority data can be stored, e.g. on the computer hard disk. In another example, the processor can be embedded in an ASIC carrying also memory for data storage, this ASIC being installed in a dedicated case where required connectors are also installed. As long as the highest priority data transmission does not terminate at step 510, the signal filtering processor branches to step 506 and continues to transmit the highest priority data and possibly to store the lower priority data at step 509. However, when at step 510 the highest priority communication terminates, the signal filtering processor starts reading the stored lower priority data at step 511, and again branches back to step 506 where it starts to transmit lower priority data, which, being now the only data, constitutes the instant highest priority data. If there is still insufficient data volume to transmit all the previously stored lower priority data, the flow continues. The signal filtering processor terminates when all data is transmitted, that is when there is no more “highest priority data” to transmit at step 508.

The various embodiments described so far, with or without the optical filter, all result in optical signal components carried by carriers propagating along an optical fiber cable, the signals being characterized by specific amplitudes, which correspond to the nature of the propagating signal. The carrier is characterized by a certain deflection angle.

Being characterized by a known deflection angle, it is possible to compute the exact location where a certain carrier (carrying one or more specific optical signal components) would impinge on the optical fiber's wall. According to one embodiment, a holographic notch filter (commercially available examples being manufactured by Oriel under catalog numbers 53680-53686) is located at the computed location. Such a filter permits a signal component with a specific wavelength (carried by the impinging carrier and characteristic of the used filter) to continue propagating further on, without deflecting back into the optical fiber's interior. By such means, the signal component is extracted from the optical fiber toward a respective path, creating another signal component.

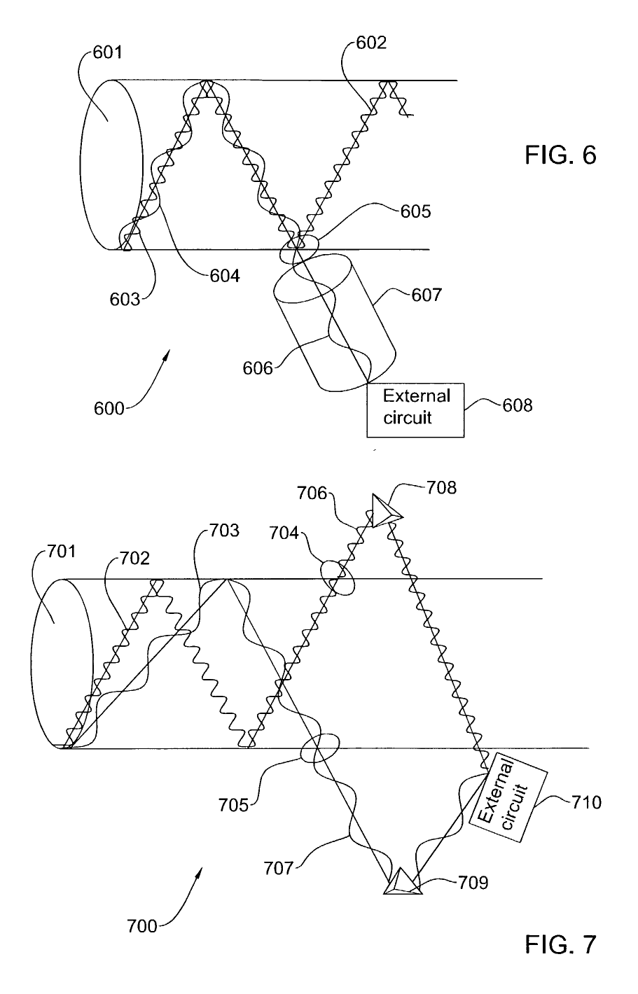

FIG. 6 illustrates a system 600 for filtering an optical signal component characterized by a specific wavelength so as to exit an optical fiber 601. A carrier 602 propagates along the optical fiber 601 and carries two optical signal components 603, 604. A filter 605 for a certain wavelength is disposed on an external wall of the optical fiber 601 at a computed location as explained above. When the carrier 602 impinges on the filter 605, the optical signal component 604 is extracted from the optical fiber 601, further creating another optical signal component 606, which propagates over an auxiliary optical fiber 607. The carrier 602 continues to propagate along the optical fiber 601, carrying optical signal component 603.

It should be noted that in order to extract a signal component from within the optical fiber, other optical means beside a filter can be used. For example, a mirror may be used to deflect the carrier, or a beam splitter may be used such as a polka dot beam splitter (commercially available examples being Oriel's polka dot beam splitters, catalog numbers 38105-38106). Both allow propagation of a first component of the carrier along the optical fiber while extracting a second component of the same carrier. Thus, assuming the carrier originally carries two optical signal components, which may be characterized, for example by different wavelengths, one optical signal component may continue to propagate along the optical fiber carried by the first carrier component, while the other optical signal component may be deflected out of the optical filter by the beam splitter, when carried on the second carrier component. In the case of two different optical signal components characterized by the same wavelength but being orthogonal in phase, a prism may be used to separate the two waves and orient them towards different respective paths. Note also that any combination of optical means can also be used, i.e. a mirror and a prism.

One or more external circuits 608 can be coupled to the optical fiber 607, to be activated by the optical signal components 606. For example, assume that the optical signal component 604 carries audio data. By deflecting it into another optical signal component 606, and by coupling to it an external circuit 608 in the form of a CD player, it is possible to directly play the audio data represented by the optical data component 606 by the optical CD player without needing first to convert it to electromagnetic data, as would be required using a system designed according to WO 01/13661. There might also be two external circuits (not shown) coupled to the optical fiber, both activated by the same optical component. In the example above, two CD players might play the same audio data.

FIG. 7 illustrates a system 700 for combining two different optical signal components propagating through an optical fiber 701 in order to activate a single external circuit disposed external to a wall of the optical fiber. Two optical signal components 702, 703, carried by two respective carriers, can be extracted from the optical fiber 701 by two different optical means 704 and 705, thereby generating two other optical signal components 706 and 707 respectively. It is possible to further deflect the two optical signal components 706 and 707, for example by using prisms 708, 709, so to direct the optical signal components towards a common location where a single external circuit 710 is located. It should be noted that there may propagate along the optical fiber 701 other optical signal components (not shown), which are not conveyed to the single external circuit 710.

This embodiment may be useful mainly when the data required to activate the external circuit is too large to transmit by a single optical (and possibly also electromagnetic) wave component. Consider, for example, that a movie, composed of a succession of video images and of audio, must be transmitted to a video projector connected through a mobile telephone, and possibly also by multiple mobile telephones. The movie is too large to be transmitted as a single unified signal to a single mobile telephone. Therefore, it is preferable to split the movie into two signal components, the first signal component carrying the succession of video images and the second signal component carrying the audio component. The two signal components can form a single composite signal having lower bandwidth than the bandwidth occupied by the original movie. Thus, this composite signal can be transmitted toward a single mobile telephone. However, it is also possible to transmit the two signal components to two different mobile telephones.

By receiving the two signal components and converting them to two optical signal components, the invention overcomes the large bandwidth problem. However, it is now required to re-combine both optical signal components to form together the full motion video at the video projector, which is the external circuit according to this example. This can be performed by the system 700 described above with reference to FIG. 7 of the drawings.

In the method claims that follow, alphabetic characters and Roman numerals used to designate claim steps are provided for convenience only and do not imply any particular order of performing the steps.

The present invention has been described with a certain degree of particularity, and accordingly those versed in the art will readily appreciate that various alterations and modifications may be carried out without departing from the scope of the following claims. In saying this, it will be appreciated by those skilled in the art that the features defined by the subsidiary claims may be combined. Thus, for example, a system according to the invention may include multiple communication devices and/or multiple external circuits, each having the relevant features set out in the appended claims relating to a system having a single communication device and a multiple external circuit only.

1. A system for communicating a signal between a communication device and an external circuit, the system comprising:
a signal conversion unit connected to said communication device responsive to a received electromagnetic signal for producing a corresponding optical signal component, and
an optical fiber cable coupling said signal conversion unit to the external circuit for propagating said optical signal component to the external circuit;
characterized in that:
a signal filtering processor is coupled between said communication device and said signal conversion unit for processing the electromagnetic signal prior to converting to the optical signal component.

2. The system according to claim 1, wherein the received electromagnetic signal is a composite electromagnetic signal comprising at least two electromagnetic signal components and the signal filtering processor is responsive to said at least two electromagnetic signal components for producing respective optical signal components.

3. The system according to claim 1 wherein the signal filtering processor is bi-directional.

4. The system according to claim 1 wherein the signal conversion unit is bi-directional.

5. The system according to claim 1 wherein both the signal filtering processor and the signal conversion unit are bi-directional thereby allowing the communication device to receive and transmit data simultaneously.

6. The system according to claim 1, wherein the optical signal component is deflected out of a wall of the optical fiber to the external circuit.

7. The system according to claim 6, wherein the optical signal component is conveyed to the external circuit via an auxiliary optical fiber cable.

8. The system according to claim 2 wherein the signal filtering processor is configured to perform time slot division of said received electromagnetic signal components.

9. The system according to claim 2 wherein the signal filtering processor is configured to perform frequency and phase division of said received electromagnetic signal components.

10. The system according to claim 2, wherein at least one of the optical signal components is deflected out of a wall of the optical fiber to the external circuit.

11. The system according to claim 10, wherein at least one of the optical signal components is conveyed to the external circuit via an auxiliary optical fiber cable.

12. The system according to claim 1, comprising at least two communication devices each coupled to the signal filtering processor, the signal filtering processor being responsive to a respective electromagnetic signal received from each of said communication devices for producing a corresponding optical signal component.

13. The system according to claim 12, wherein at least one of the received electromagnetic signals is a composite electromagnetic signal comprising at least two electromagnetic signal components and the signal filtering processor is responsive to said at least two electromagnetic signal components for producing respective optical signal components.

14. The system according to claim 12, wherein each of said communication devices is characterized by a respective communication protocol and transport.

15. The system according to claim 12 wherein the signal filtering processor is bi-directional.

16. The system according to claim 12 wherein the signal conversion unit is bi-directional.

17. The system according to claim 12 wherein both the signal filtering processor and the signal conversion unit are bi-directional thereby allowing each of said communication devices to receive and transmit data simultaneously.

18. The system according to claim 12 wherein the signal filtering processor is configured to perform time slot division of said received electromagnetic signal components.

19. The system according to claim 12 wherein the signal filtering processor is configured to perform frequency and phase division of said received electromagnetic signal components.

20. The system according to claim 12, wherein at least one of the optical signal components is deflected out of a wall of the optical fiber to the external circuit.

21. The system according to claim 12, wherein at least one of the optical signal component is conveyed to the external circuit via an auxiliary optical fiber cable.

22. The system according to claim 13 wherein the signal filtering processor is configured to perform time slot division of said received electromagnetic signal components.

23. The system according to claim 13 wherein the signal filtering processor is configured to perform frequency and phase division of said received electromagnetic signal components.

24. The system according to claim 13, wherein at least one of the optical signal components is deflected out of a wall of the optical fiber to the external circuit.

25. The system according to claim 24, wherein at least one of the optical signal component is conveyed to the external circuit via an auxiliary optical fiber cable.

26. The system according to claim 1, comprising at least two external circuits each for receiving said optical signal component.

27. The system according to claim 26, wherein the received electromagnetic signal is a composite electromagnetic signal comprising at least two electromagnetic signal components and the signal filtering processor is responsive to said at least two electromagnetic signal components for producing respective optical signal components.

28. The system according to claim 26 wherein the signal filtering processor is bi-directional.

29. The system according to claim 26 wherein the signal conversion unit is bi-directional.

30. The system according to claim 26 wherein both the signal filtering processor and the signal conversion unit are bi-directional thereby allowing the communication device to receive and transmit data simultaneously.

31. The system according to claim 26, wherein the optical signal component is deflected out of a wall of the optical fiber to one of the external circuits.

32. The system according to claim 26, wherein the optical signal components is conveyed to the external circuit via an auxiliary optical fiber cable.

33. The system according to claim 27 wherein the signal filtering processor is configured to perform time slot division of said received electromagnetic signal components.

34. The system according to claim 27 wherein the signal filtering processor is configured to perform frequency and phase division of said received electromagnetic signal components.

35. The system according to claim 27, wherein at least one of the optical signal components is deflected out of a wall of the optical fiber to one of the external circuits.

36. The system according to claim 35, wherein at lest one of the optical signal components is conveyed to the external circuit via an auxiliary optical fiber cable.

37. The system according to claim 26, comprising at least two communication devices each coupled to the signal filtering processor, the signal filtering processor being responsive to a respective electromagnetic signal received from each of said communication devices for producing a corresponding optical signal component.

38. The system according to claim 37, wherein at least one of the received electromagnetic signals is a composite electromagnetic signal comprising at least two electromagnetic signal components and the signal filtering processor is responsive to said at least two electromagnetic signal components for producing respective optical signal components.

39. The system according to claim 37, wherein each of said communication devices is characterized by a respective communication protocol and transport.

40. The system according to claim 37 wherein the signal filtering processor is bi-directional.

41. The system according to claim 37 wherein the signal conversion unit is bi-directional.

42. The system according to claim 37 wherein both the signal filtering processor and the signal conversion unit are bi-directional thereby allowing each of said communication devices to receive and transmit data simultaneously.

43. The system according to claim 37 wherein the signal filtering processor is configured to perform time slot division of said received electromagnetic signal components.

44. The system according to claim 37 wherein the signal filtering processor is configured to perform frequency and phase division of said received electromagnetic is signal components.

45. The system according to claim 37, wherein at least one of the optical signal components is deflected out of a wall of the optical fiber to one of the external circuits.

46. The system according to claim 45, wherein at lest one of the optical signal components is conveyed to the external circuit via an auxiliary optical fiber cable.

47. The system according to claim 38 wherein the signal filtering processor is configured to perform time slot division of said received electromagnetic signal components.

48. The system according to claim 38 wherein the signal filtering processor is configured to perform frequency and phase division of said received electromagnetic signal components.

49. The system according to claim 38, wherein at least one of the optical signal components is deflected out of a wall of the optical fiber to one of the external circuits.

50. The system according to claim 49, wherein at lest one of the optical signal components is conveyed to the external circuit via an auxiliary optical fiber cable.

51. A system for communicating a signal between a communication device and an external circuit, the system comprising:
a signal conversion unit connected to said communication device responsive to a received electromagnetic signal for producing a corresponding optical signal, and
an optical fiber cable coupling said signal conversion unit to the external circuit for propagating said optical signal to the external circuit;
characterized in that:
a signal filtering processor is coupled between at least one said communication device and said signal conversion unit for identifying and processing the electromagnetic signal prior to converting to the optical signal, and
an optical filter is coupled between the signal conversion unit and the optical fiber for receiving the optical signal and producing at least one corresponding filtered optical signal component.

52. The system according to claim 51, wherein the received electromagnetic signal is a composite electromagnetic signal comprising at least two electromagnetic signal components and the signal filtering processor is responsive to said at least two electromagnetic signal components for producing respective optical signal components.

53. The system according to claim 51, wherein the signal filtering processor is bi-directional.

54. The system according to claim 51 wherein the signal conversion unit is bi-directional.

55. The system according to claim 51 wherein the optical filter is bi-directional.

56. The system according to claim 52 wherein the signal filtering processor is configured to perform time slot division of said electromagnetic signal components.

57. The system according to claim 52 wherein the signal filtering processor is configured to perform frequency and phase division of said electromagnetic signal components.

58. The system according to claim 51, wherein the optical filter is responsive to a control signal fed thereto by the signal filtering processor for selectively passing the optical signal components.

59. The system according to claim 52, wherein the optical filter is responsive to a control signal fed thereto by the signal filtering processor for selectively passing the optical signal components.

60. The system according to claim 59 wherein the signal filtering processor controls the optical filter for selectively performing time slot division of said optical signal components.

61. The system according to claim 59 wherein the signal filtering processor controls the optical filter for selectively performing frequency and phase division of said optical signal components.

62. The system according to claim 51 comprising at least two communication devices each coupled to the signal filtering processor, the signal filtering processor being responsive to a respective electromagnetic signal received from each of said communication devices for producing a corresponding optical signal component.

63. The system according to claim 62 wherein each communication device is characterized by a respective communication protocol and transport.

64. A method for communicating a signal between a communication device and an external circuit, the method comprising:
One) processing an electromagnetic signal output by the communication device for automatically identifying a respective communication protocol thereof,
Two) filtering the electromagnetic signal prior to converting to an optical signal component,
Three) converting the electromagnetic signal to the optical signal component, and
Four) conveying the optical signal component via an optical fiber cable to the external circuit.

65. The method according to claim 64, further comprising:
Five) selectively filtering said optical signal component for selectively producing a corresponding filtered optical signal component.

66. The method according to claim 65, including controlling an optical filter for selectively producing a filtered optical signal component.

67. The method according to claim 64, further comprising:
Five) deflecting the optical signal component out of a wall of the optical fiber and
Six) conveying the optical signal component to an external circuit.

68. The method according to claim 64 further comprising:
Five) deflecting the optical signal component out of a wall of the optical fiber and
Six) conveying the optical signal component via an auxiliary optical fiber to an external circuit.

69. The method according to claim 68 further including conveying at least two optical signal components to a single external circuit.

70. The method according to claim 68 further including deflecting the at least two optical signal components, each towards a respective first end of a respective optical fiber having a respective second end in optical communication with the single external circuit.
